(19) United States
(12) Patent Application Publication
(10) Pub. No.: US 2004/0001113 A1
(43) Pub. Date: Jan. 1, 2004

(54) Method and apparatus for spline-based trajectory classification, gesture detection and localization

(76) Inventors: John Zipperer, Beaverton, OR (US); Fernando C.M. Martins, Hillsboro, OR (US)

Correspondence Address: Pillsbury Winthrop LLP, Intellectual Property Group, 725 South Figueroa Street, Suite 2800, Los Angeles, CA, 90017-5406, US

(21) Appl. No.: 10/185,579

(22) Filed: Jun. 28, 2002

(51) Int. Cl. G09G 5/00

(52) U.S. Cl. 345/853; 345/863

(57) ABSTRACT

A gesture classification method includes receiving position data. A detected spline is generated based on the position data. A normalization scheme is applied to the detected spline to generate a normalized spline. A goodness value is determined by comparing the normalized spline with gesture splines representing gestures stored in a gesture database.

### BACKGROUND

1. Technical Field

An embodiment of this invention relates to the field of gesture detection and localization, and more specifically, to a system, method, and apparatus for detecting and classifying a gesture represented in a stream of positional data.

2. Description of the Related Arts

There are current gesture detection systems in the art for acquiring a stream of positional data and determining what gestures, if any, are represented in the stream of positional data. The stream of positional data often includes data representing multiple gestures. Such systems typically provide a start and an end point of a gesture represented in the positional data, and then compare the positional data located between the start and the end points with data representing a set of known gestures. The known gesture which most closely resembles the positional data located between the start and end points is then determined to be the gesture represented, and is returned as the represented gesture.

Such systems are deficient, however, because the start and the end points must be known prior to determining the gesture represented. In other words, the system cannot determine which gesture is represented unless prior knowledge about the start and the end points is provided. Also, such systems typically return the gesture most closely matching the positional data between the start and the end points, even if the correlation between the most closely matching gesture and the positional data between the start and the end points is very small.

### BRIEF DESCRIPTION OF THE DRAWINGS

FIG. 1A illustrates a spline according to an embodiment of the invention;

FIG. 1B illustrates a spline and associated control points (i.e., first control point, second control point, third control point, fourth control point, fifth control point, sixth control point, and seventh control point) according to an embodiment of the invention;

FIG. 2 illustrates a gesture recognition device according to an embodiment of the invention;

FIG. 3A illustrates a raw data acquisition device utilizing a mouse according to an embodiment of the invention;

FIG. 3B illustrates a raw data acquisition device utilizing an I/O device according to an embodiment of the invention; FIG. 3C illustrates a raw data acquisition device utilizing a touchpad according to an embodiment of the invention;

FIG. 3D illustrates a raw data acquisition device utilizing a videocamera according to an embodiment of the invention;

FIG. 4 illustrates a spline-generating method according to an embodiment of the invention;

FIG. 5 illustrates an expanded view of the normalization device according to an embodiment of the invention;

FIG. 6 illustrates a normalization process according to an embodiment of the invention;

FIG. 7 illustrates a goodness determination method according to an embodiment of the invention;

FIG. 8A illustrates a first part of a process to detect a gesture according to an embodiment of the invention; and

FIG. 8B illustrates a second part of the process to detect a gesture according to an embodiment of the invention.

### DETAILED DESCRIPTION

An embodiment of the invention may receive a stream of positional data and determine whether a predetermined gesture is represented by the positional data within the stream. The stream may be sampled positional data of a user waving his/her hand in front of a video camera, or a user moving a mouse or a finger moving while in contact with a touchpad, for example. An embodiment may determine whether a gesture (e.g., waving or writing the number “2”) is represented based on a comparison of the data in the data stream with prestored data relating to known gestures. The prestored data relating to known gestures may be stored as a spline such as a B-spline in a memory. A B-spline is a type of parametric curve. A B-spline may be represented by parametric basis functions (or alternatively by knot vectors) and weights. The basis functions (or knot vectors) and weights may be utilized to represent a plurality of curved line segments that together form the B-spline. Each of the curved segments may be associated with a set of control points. Each of the control points is a weighting factor for a basis function which is defined over an interval. Each of the curved segments may have its own set of control points. The curved segments may share some control points with adjacent curved segments.

A B-spline is one specific type of parametric curve of which there are several. These types of curves may be used extensively in Computer Aided Design (CAD) and other graphics applications requiring compound, non-circular curves.

A B-spline is defined by an ordered set of control points or control polygon, and parametric basis functions, which determine what path the curve will follow and consequently how the curve will look. A point on a particular curve segment may be calculated by summing the coordinate values of the curve's defining control points after they have been multiplied by the parametric basis functions. For each curve segment, a subset of basis functions are defined. The value of the basis functions across the range of the parameter multiplied by the control point's coordinates define a number of intermediate points, which form a curve when connected.

An embodiment may compare sets of positional data from the positional data stream with gestures stored in a memory to determine (a) whether a gesture is represented in the data set, and (b) how closely the data set represents the closest matching gesture. The sets of positional data may be formed by the minimal number of data points necessary to represent a gesture, or by the maximum number of data points necessary to represent a gesture. A B-spline may then be determined for the data set, and compared with B-splines represented by the gestures in the memory.

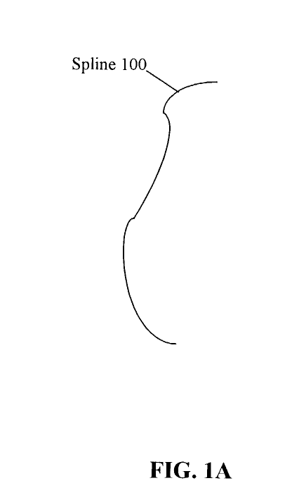

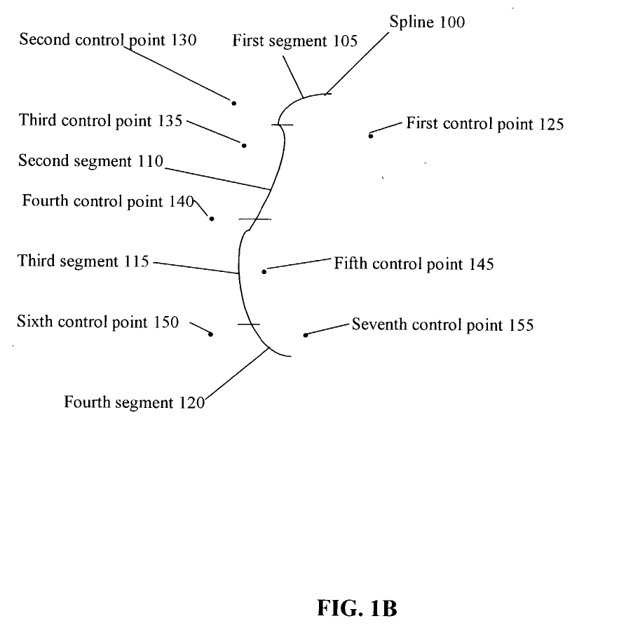

FIG. 1A illustrates a spline 100 according to an embodiment of the invention. The spline 100 may be generated based upon a set of input data. For example, a user may move a mouse in different directions, changing the direction of the mouse at various times. A computing device may then acquire positional data from the mouse and supply such positional data to a processing device. The processing device may represent the user's movement of the mouse as the curved spline 100. The spline 100 may be a B-spline, for example. The processing device may then determine a parametric function to represent the spline 100. In other embodiments, a positional data input device other than a mouse may be utilized. For example, a camera may sample digital images and determine the movement of an object in the image, such as the user's finger, to determine the positional data.

FIG. 1B illustrates the spline 100 and associated control points (first control point 125, second control point 130, third control point 135, fourth control point 140, fifth control point 145, sixth control point 150, and seventh control point 155) according to an embodiment of the invention. The spline 100 may be represented as the combination of several curved segments (e.g., first segment 105, second segment 110, third segment 115, and fourth segment 120). Each of the line segments may be represented by a parametric curve that is a function of a single variable. The variable may be time, for example. In an embodiment, the first segment 105 may be represented by a function of the first control point 125, the second control point 130, the third control point 135, and the fourth control point 140. For example, the function for the first line segment 105 as a function of time may be L₁(t)=C₁(t)P₁+C₂(t)P₂+C₃(t)P₃+C₄(t)P₄, where t is a measurement of time, and C₁, C₂, C₃, and C₄ are basis functions, and P₁, P₂, P₃, and P₄ represent the first four control points, 125, 130, 135, and 140, respectively.

Accordingly, a spline 100 is a multi-segment curve defined by parametric basis functions (or alternatively by knot vectors) and weights. The actual points that the segments pass through may be defined by the sum of weights times basis functions value, for every point that the basis function is defined. Typically, the basis functions are defined only on a small interval, meaning that the weights only affect the curve in some small locality. A control point may generally only effect a couple of curve segments. In the case of 2-dimensional splines, there are actually 2 weights (one for the x-direction, and one for the y-direction) and these weights are known as the control point.

In the spline 100 of FIG. 1B, the first 125, second 130, third 135, and the fourth 140 control points may affect the shape of the first segment 105. The second 130, third 135, fourth 140, and fifth 145 control points may affect the shape of the second segment 110. The third 135, fourth 140, fifth 145, and sixth 150 control points may affect the shape of the third segment 115, etc.

The segments may be joined together at knots. These knots are not the (x, y) coordinates on the curve, rather they define changes in the parametric value used in the basis functions. Knot values can also be used to define the basis functions in a recursive manner. Knot vectors are non-decreasing sequences of knots. Knot vectors are used to define the basis functions. Examples of knot vectors include [1 2 3 4 5] or [1 11 1 2 3 4 5 5 5 5], where “1” represents the first control point 125, “2” represents the second control point 130, “3” represents the third control point 135, “4” represents the fourth control point 140, and “5” represents the fifth control point 145. By using the multiple knots in the second knot vector, the basis functions may be manipulated to cause a segment to pass through a point, have a sharp corner, etc. By manipulating the knot vectors, and the subsequent basis functions, non-smooth curves may be formed.

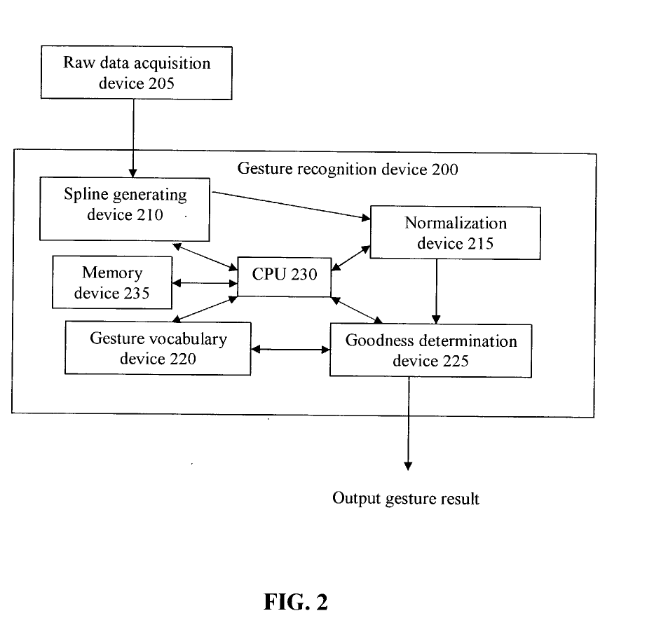

FIG. 2 illustrates a gesture recognition device 200 according to an embodiment of the invention. A raw data acquisition device 205 may acquire raw positional data and supply such data to the gesture recognition device 200. As discussed above with respect to FIG. 1A, the raw data acquisition device 205 may be a computer mouse which acquires positional data based upon directions in which a user moves the mouse, or a touchpad which calculates positional data based upon the movement of a stylus or the user's finger, for example, across the touchpad. The raw data acquisition device 205 may also be a combination of a videocamera and a processor. The videocamera may sample image of the user's movements (e.g., the movement of a neon green pen held by the user) and a processor may extract the positional data for the movement of objects of interest in the image (e.g., the movement of the pen). In other embodiments, an analysis of “pixel flow” in a series of sampled images from the videocamera may be utilized to determine the movement of an object in the sampled images. Pixel flow is the movement of pixels from one image to the next, the pixels being representative of an object in the sampled images. For example, if the user moves his/her hand, the videocamera may sample images of the user, and the processor may determine that the user's hand is moving based upon movement of pixels representing the user's hand. In other words, if the user's hands are a different color than the background, the processor may be able to track the movement of the user's hands based upon the movement of pixels representing the user's hands from one a first position in a first sampled image, to a second position in a second sampled image, to a third position in a third sampled image, etc. In an embodiment, the process may isolate the pixel flow of pixels representing the user's hands from those representing the background based upon the number of pixels moving in similar directions. For example, if the user's hands are closer to the videocamera, they may appear relatively larger than other objects in the image; accordingly, when the user moves his or her hands, more pixels may represent the user's hand than those representing objects in the background. Therefore, the movement of objects in the background may be ignored because a smaller number of pixels representing such background objects are moving from one digital image to the next.

After the raw data acquisition device 205 outputs the raw positional data, such data may be received by a spline generating device 210 of the gesture recognition device 200. The spline generating device 210 may have a function of determining a spline, such as a B-spline, based upon the raw positional data. The spline generating device 210 may have its own processor. In other embodiments, a Central Processing Unit (CPU) 230 in the gesture recognition device 200 may control the spline generating device 210.

After calculating a spline based upon the raw positional data, the data representing the calculated spline may be output to a normalization device 215. The normalization device 215 may have a function of normalizing the data representing the calculated spline. The normalization device 215 may process the data representing the calculated spline so that it can be compared with splines representing gestures stored in a gesture vocabulary device 220. The normalization device 215 may process the data to make it size-indifferent (e.g., a large spline representing a large gesture may be matched with a smaller spline representing the gesture). The data may also be rotation-indifferent, i.e., this may used to remove the effect of the user physically moving while making the gesture (e.g., the user makes a hand signal in front the videocamera while rotating counterclockwise). Finally, the data may also be made translation-indifferent, in order to get the same results regardless of whether the gesture occurs in the upper left of an image sampled from the videocamera, or in the lower right of the image, for example.

The normalized data may then be output to a goodness determination device 225, which may have a function of comparing the normalized spline with a set of splines representing gestures stored in the gesture vocabulary device 220. The gesture vocabulary device 220 may include a memory, for example, to store the splines representing gestures. The goodness determination device 225 may compare the normalized spline with each spline representing gestures and determine a “goodness” value for each of the splines representing gestures. “Goodness” may be a relative measure of how closely the calculated spline matches a stored spline. The gesture may then output data representing the stored spline having the largest goodness value or may output data indicating that the normalized spline does not match any of the stored splines if none of the stored spline have a goodness value above a minimum threshold. A minimum threshold may be utilized to ensure that a minimal amount of similarity exists between the calculated spline and a stored spline. This ensures that where the user makes a gesture not represented within the gesture vocabularly, none of the stored gestures are matched with it.

The gesture recognition device 200 may also include a memory device 235 to store instructions executable by the CPU 230 or processor in each of the: spline generating device 210, the normalization device 215 and the goodness determination device 225, as well as the gesture recognition device 200 itself, for example.

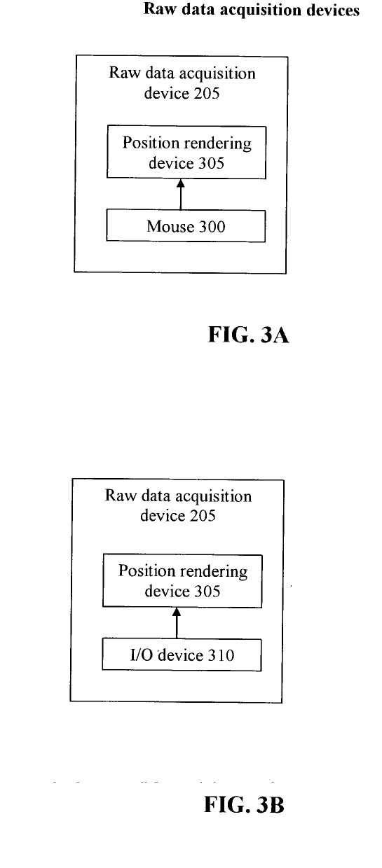

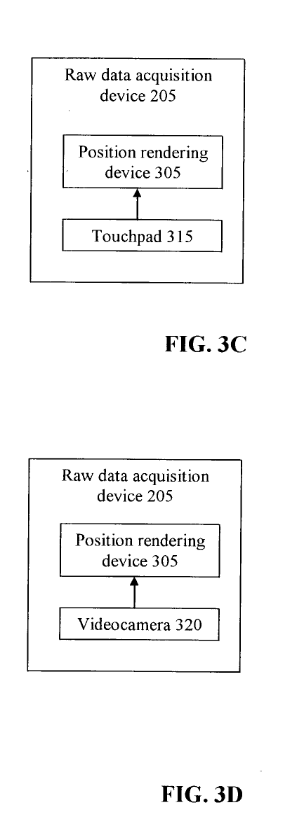

FIG. 3A illustrates a raw data acquisition device 205 utilizing a mouse 300 according to an embodiment of the invention. The mouse 300 may output raw data to a position rendering device 305, which may determine positional data based on the movement of the mouse 300. The raw data acquisition device 205 may then output the positional data to the gesture recognition device 200.

FIG. 3B illustrates a raw data acquisition device 205 utilizing an I/O device 310 according to an embodiment of the invention. The I/O device 300 may be an infrared device, which may calculate positional data based on an infrared signal received from an infrared glove or boot, for example. As a user moves the glove or boot, infrared signals may be sent to the position rendering device 305, which may determine corresponding position data, and may transmit such position data to the gesture recognition device 200.

FIG. 3C illustrates a raw data acquisition device 205 utilizing a touchpad 315 according to an embodiment of the invention. A user may touch his/her finger to the touchpad 315 and make gestures such as writing the number “2” on the touchpad 315, for example. The touchpad 315 may determine positional data based upon where the touchpad 315 is physically contacted by the user. The touchpad 315 may transmit such data to the position rendering device 305, which may determine corresponding position data, and may transmit such position data to the gesture recognition device 200.

FIG. 3D illustrates a raw data acquisition device 205 utilizing a videocamera 320 according to an embodiment of the invention. The videocamera 320 may be a digital digital videocamera, and may sample images of a user, and transmit such images to the position rendering device 305. The position rendering device 305 may determine the user's movement based by tracking the movement of pixels of a preset color through consecutively sampled images. For example, the position rendering device may track the movement of a neon green pen held by the user through consecutively sampled images. The movement of the neon green pen may be determined based upon the movement of neon green pixels between consecutively sampled images. In other words, the position rendering device 305 may track the user's movements based upon the “pixel flow” of pixels between consecutively sampled images. The raw data acquisition device 205 may then output the positional data to the gesture recognition device 200.

In other embodiments, the color of the user, or an object held by the user, need not be preset. Instead, the position rendering device 305 may determine the user's movements by determining the largest movements between consecutively sampled images (i.e., the position rendering device 305 may ignore smaller movements because they usually do not represent the gesture). In such an embodiment, smaller movements may be ignored by the position rendering device 305. Such an embodiment may require more processing power to effectively isolate the large movements of the user.

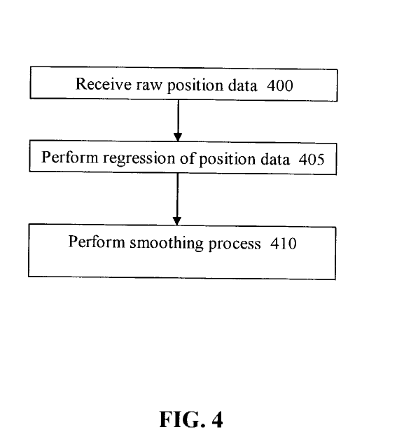

FIG. 4 illustrates a spline-generating method according to an embodiment of the invention. The spline-generating method may be utilized to form a spline based upon the raw positional data received from the raw data acquisition device 205. The spline-generating method may be implemented by the spline generating device 210, for example. First, the raw position data may be received 400 from the raw data acquisition device 205. Next, a regression of the positional data may be performed 405. The regression may be a method of fitting a curve through a set of points minimizing a function until a goodness value is determined. A smoothing process may also be performed 410. The smoothing process may be a method for modifying a set of data to make a resulting curve smooth and nearly continuous and remove or diminish outlying points. Regression and smoothing are similar methods of fitting curves to a set of data points, with smoothing proving more control over error. The spline-generating method may be implemented by a processor within the spline generating device 210, or by the CPU 230, for example.

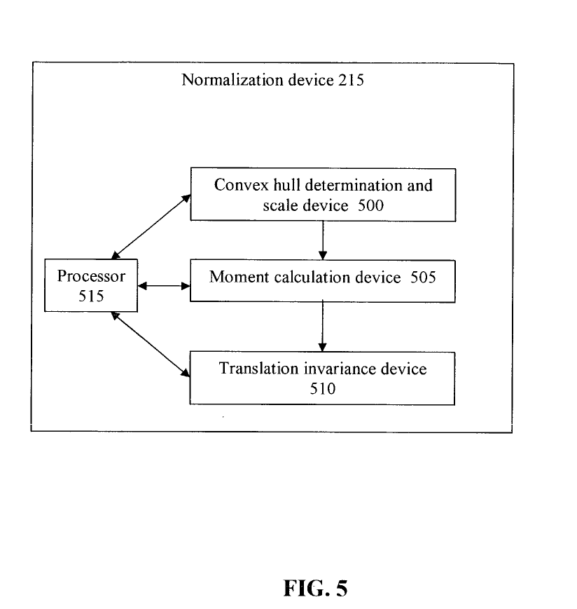

FIG. 5 illustrates an expanded view of the normalization device 215 according to an embodiment of the invention. The normalization device 215 may include a convex hull determination and scale device 500. A convex hull is the smallest-sized shape which may be used as a container of a set of data points. For example, the convex hull is analogous to stretching a rubber band around the outside of the data points. Once the convex hull of the spline has been determined, the convex hull can be scaled to a predetermined size. The scaling may be used to ensure that a particular gesture can be recognized regardless of whether a small movement was used to make the gestures versus a large movement to make the gesture. For example, if a touchpad 315 is used, the user may use a stylus to make a small “2”, or the user may draw a large “2”. The convex hulls of the spline and the control points representing each of the small and the large “2” may be scaled to the same size. Accordingly, the scaled convex hull of the small “2” would be substantially identical to the scaled convex hull of the large “2”.

The normalization device 215 may also include a moment calculation device 505. The moment calculation device 505 may be used to calculate a moment of the calculated spline and control points. The moment calculation device 505 may also remove the effects of the rotation about a moment while the gesture was made. In other words, if a user were drawing a letter on the touchpad 315 of FIG. 3C while simultaneously physically rotating his/her body, the drawn letter may appear to twist about a moment, thereby skewing the drawing of the letter. The moment calculation device 505 may be used to remove the effect of such rotation after a moment has been calculated for a calculated spline.

The normalization device 215 may also include a translation invariance device 510. The translation invariance device may be utilized to remove the effect of the user making a gesture at a varying rate of speed. For example, if the user is drawing a letter on the touchpad 315, the user might draw the beginning portion of the letter more quickly than the end portion of the letter. Accordingly, if the sampling rate is constant, fewer sampled points may be acquired while the user drew the end portion than those acquired while the user drew the beginning portion. Accordingly, it may be necessary to account for the speed change to prevent erroneous results. The translation invariance device 510 may therefore be utilized to detect and remove the effect of a speed change while the user drew the letter.

The normalization device 215 may include a processor 515 to control the convex hull determination and scale device 500, the moment calculation device 505, and the translation invariance device 510. Alternatively, each of the aforementioned devices may include their own processors.

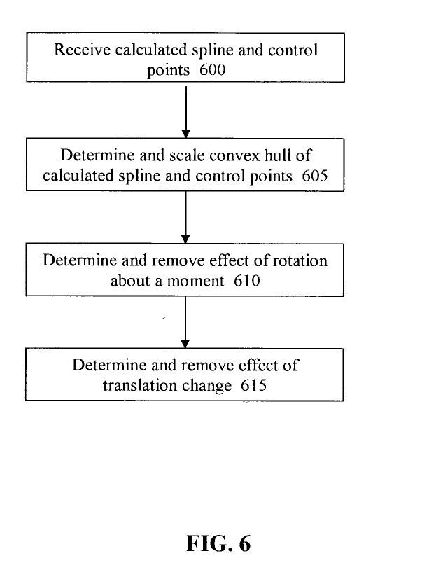

FIG. 6 illustrates a normalization process according to an embodiment of the invention. First, the calculated spline and control points may be received 600 from the spline generating device 210. Next, a convex hull of the calculated spline and control points is determined 605 and scaled. The effected of rotation about a moment is then determined 610 and removed. Finally, the effect of a translation change is determined 615 and removed.

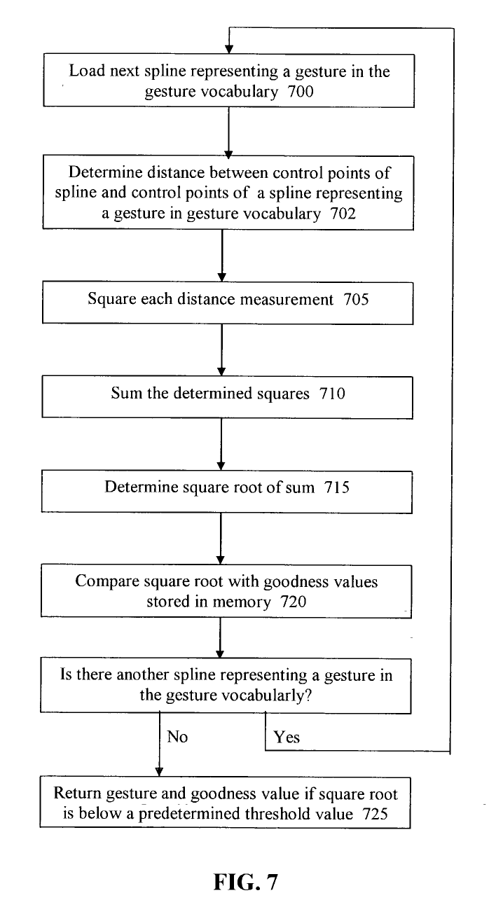

FIG. 7 illustrates a goodness determination method according to an embodiment of the invention. The goodness determination method may be implemented by the goodness determination device 225, for example. The goodness determination method may be utilized to compare the calculated spline with splines representing gestures of the gesture vocabulary device 220. The spline for each gesture may include a knot vector and associated control points. The goodness determination device may have a minimum threshold of “goodness” or correlation that a calculated spline must have with a spline represented in the gesture vocabulary in order to be matched up with the gesture.

According to the goodness determination method, a spline representing a gesture in the gesture vocabulary may be loaded 700 into a memory. Next, a “distance” between the control points of the calculated spline and the control points of a spline representing the gesture in the gesture vocabulary is determined 702. The “distance” may be a measurement of how correlated a control point of the calculated spline is with a control point of a spline representing a gesture stored in the gesture vocabulary.

Each distance measurement may then be squared 705. In other words, if a calculated spline has “5” control points and a spline representing a gesture stored in the gesture vocabulary also has “5” control points, the distance between the first control point of the caculated spline and the first control point of a stored spline may be determined and calculated. Likewise, the ditance between the second control point of the calculated spline and the second control point of the stored spline may be determined and squared, and so on.

The calculated squares of the distance measurements may then be summed 710. The square root of the sum may then be determined 715. The calculated square root may then be compared 720 with goodness values stored in memory. At operation 725, if another spline representing another gesture is still present in the gesture vocabulary, the processing continues at operation 700. If no more splines are left, however, processing proceeds to operation 730, where a gesture having the highest goodness value is returned, if it exists, provided the square root is below a predetermined threshold value. The gesture that is returned may be the gesture most closely matching a gesture made by the user.

The mathematical computations by which the goodness value is calculated in the method of FIG. 7 is known as an “L2 norm.” The L2 norm for a set of distances [x1, . . . , xn] is defined as (with xᵣ representing a distance):

$$L2 norm = \sqrt{{\sum }_{r = 1}^{n} {\vert {x}_{r} \vert}^{2}}$$

According to the gesture determination method, only the gesture most closely matching (i.e., having the highest goodness value) the gesture made be the user may be determined to be the matching gesture from the gesture vocabulary. The calculated spline from the data representing user's gesture may be compared against each spline representing the gestures stored in the gesture vocabulary.

Only the gesture most closely matching that of the user's gesture may be returned, provided the goodness value is above a minimum threshold goodness value. Therefore, if the gesture made by the user does not closely match any of the stored gestures, then no gesture may be returned.

Another aspect of an embodiment of the invention is directed to gesture localization (i.e., determining the presence of a gesture is a set of raw data). Gesture localization may be necessary before the gesture detection described above with respect to FIGS. 1-7 may take place. In other words, prior to detecting the gesture and matching it with a gesture of the gesture vocabulary, raw data representing a gesture may first be extracted from a stream of raw data. The key is to determine the existence of an intentional gesture in a raw data trajectory. For gesture localization, the raw data may be analyzed and a pair of pointers may be utilized to indicate the first point of the data representing the start of a gesture and the last point of the raw data representing the end of a gesture.

Given a trajectory T(x), where T represents a set of the raw data and x represents time, the gesture localization method may be utilized to determine the start and end points, e.g., xₛₜₐᵣₜ and x_{end} of a gesture in the trajectory T(x). The system may have prior knowledge based on the minimum and maximum acceptable lengths of time during which a complete gesture may be made. For example, a valid gesture may be made between “4” and “8” seconds. In such a situation, an amount of the raw positional data may be tested for “4”-“8” second intervals to determine whether a gesture was likely made.

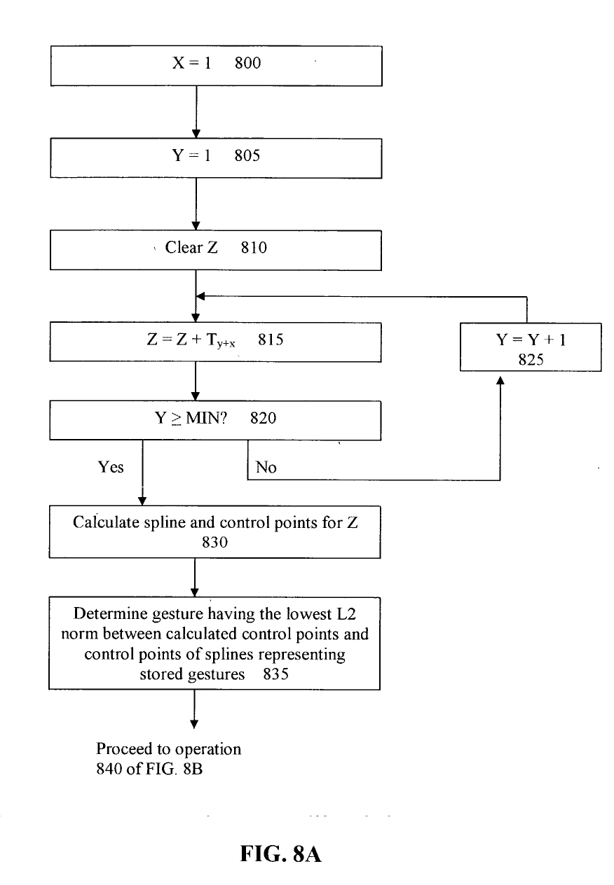

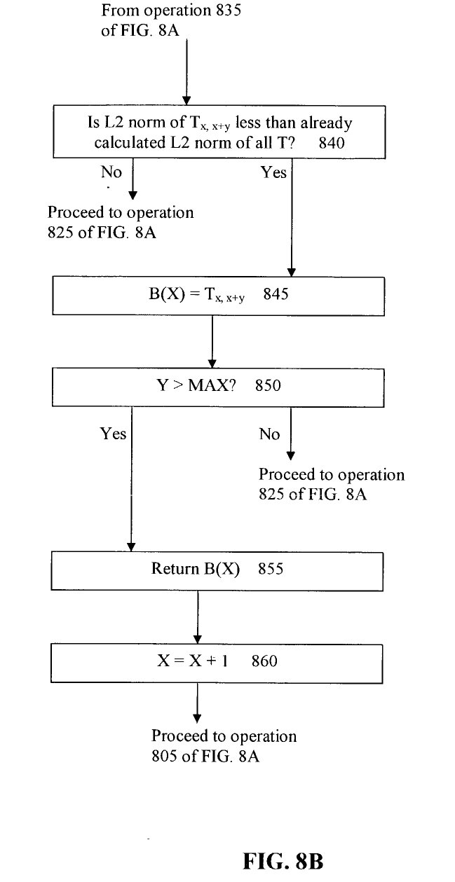

FIG. 8A illustrates a first part of a process to detect a gesture according to an embodiment of the invention. First, counter X is set 800 to “1”. Counter X may be utilized to represent the starting point in a set of data (e.g., set “Z”) of the position data in which to search for a gesture. Next, counter Y may be set 805 to “0”. Data set Z may then by cleared 810. Data set Z may be utilized to store a set of position points in which to search for a gesture. Next, data point T_{y+x} is added 815 to data set Z. An entire set of positional data points, {T1, T2, . . . , Tn} may be received from the raw data acquisition device 205 and may be continually searched for a gesture. Next, the process may determine 820 whether counter Y is greater than or equal to MIN. MIN may be a value equal to the minimal amount of data points used to represent a known gesture. More specifically, the system may have prior knowledge about the minimum length of time necessary to make a known gesture. Then, based upon the sampling rate of a data acquisition device, the system may then determine how many data point would be present with than known time interval. At operation 820, if the answer is “no,” counter Y may be incremented 825, and then processing may continued at operation 815. Accordingly, the positional data in data set Z is only analyzed for gestures after a minimum number of data points (i.e., MIN) are stored in data set Z. However, at operation 820, if the answer is “yes,” processing may proceed to operation 830. If the answer is “yes” at operation 820, then the system has determined that the minimum amount of data points necessary to represent a gesture is currently stored in data set Z.

At operation 830, the spline and control points for data set Z may be determined. Next, the calculated spline may be compared with every spline representing a gesture in the gesture vocabulary, and the gesture having the lowest L2 norm between its control points and the control points for data set Z may be determined 835.

FIG. 8B illustrates a second part of the process to detect a gesture according to an embodiment of the invention. The method may determine 840 whether the L2 norm of T_{x, x+y} is less than any other L2 norm already calculated for data set T. If “no,” processing returns to operation 825. If “yes,” processing proceeds to operation 845, where B(X) is loaded with T_{x, x+y}. B(X) may be used to stored the gesture resulting in the lowest L2 norm. Next, the processing determines 850 whether counter Y is greater than MAX, a value representing the number of data points necessary to represent the longest allowable gesture. If “yes,” the value stored in B(X) is returned 855, as the gesture. In other embodiments, the system may only return B(X) if the L2 norm stored in B(X) exceeds a minimum threshold.

Counter X may then be incremented 860, and the process may repeat at operation 805, where the system may search for gestures within a data set beginning with the second positional point. In other embodiments, counter X may be incremented by a value equal to the total number of data points in data set Z that resulted in the lowest L2 norm, for example.

In other embodiments, an implementation of a conjugate gradient process may be utilized to determine whether a gesture has been made. In such an embodiment, the system may take turns fixing one parameter and minimizing the other. The conjugate gradient process may be utilized to find the minimum in the data set. In real conjugate gradient methods, a recursive process may be utilized to solve a system of equations. One parameter may be varied at a time, the minimum value may be determined, and this minimum may then be utilized while varying another parameter, etc. The process may repeat until convergence.

In this case, first fixing the beginning the of data set Z, (i.e., Tₓ) and searching for the end point of data set Z that yields the data set most closely matching (i.e., having the lowest L2 norm) and vice-versa until convergence. To expedite spline-fitting computations, a course to fine pyramid scheme may also be implemented. The pyramid scheme may be utilized to calculate local values (at a low level in the pyramid) and combine them together (at a higher level in the pyramid). This may be used to calculate local spline segments and combine the segments together into the larger spline. In an embodiment, there may be the possibility that an additional point to the end of a potential spline does not require a recomputation of the complete spline, but instead can use this pyramid scheme technique. Also, a sub-sampling technique may be used where only every 4th data point (or the mean of every 4 data points) to speed up processing, for example.

Embodiments of the invention may be utilized for a dancing game, for example. The user may perform dance moves in front of a videocamera 320, and the system may determine gestures (i.e., the dance moves) of the user and may provide an accuracy score that is related to the goodness value of the user's gestures.

Other embodiments may be used with a sign language instruction program. The user may make sign language signs in front of the videocamera, and the system may determine gestures (i.e., the signs) of the user and may provide an accuracy score that is related to the goodness value of the user's signs.

Additional embodiments may be used with a writing instruction program, for example. The user may write letters or words on the touchpad 315, and the system may determine gestures (i.e., written letters or words) and may provide an accuracy score that is related to the goodness value of the user's written letters or words.

While the description above refers to particular embodiments of the present invention, it will be understood that many modifications may be made without departing from the spirit thereof. The accompanying claims are intended to cover such modifications as would fall within the true scope and spirit of an embodiment of the present invention. The presently disclosed embodiments are therefore to be considered in all respects as illustrative and not restrictive, the scope of an embodiment of the invention being indicated by the appended claims, rather than the foregoing description, and all changes which come within the meaning and range of equivalency of the claims are therefore intended to be embraced therein.

What is claimed is:

1. A gesture classification method, comprising:
receiving position data;
generating a detected spline based on the position data;
applying a normalization scheme to the detected spline to generate a normalized spline; and
determining a goodness value by comparing the normalized spline with gesture splines representing gestures stored in a gesture database.

2. The method according to claim 1, wherein the normalization scheme includes determining and scaling a convex hull of the detected spline.

3. The method according to claim 1, wherein the normalization scheme includes determining at least one moment of the detected spline.

4. The method according to claim 1, wherein the normalization scheme includes implementing a translation invariance scheme.

5. The method according to claim 1, wherein the normalized spline includes a normalized basis function and a predetermined number of normalized control points.

6. The method according to claim 1, wherein each of the gesture splines include a gesture basis function and gesture control points.

7. The method according to claim 1, wherein the goodness value is determined after calculating an L2 norm of the distances between respective normalized control points and gesture control points of the gesture splines.

8. The method according to claim 7, wherein a matching gesture is returned if the goodness value is above a predetermined threshold.

9. The method according to claim 1, wherein the spline is a B-spline.

10. A gesture detection method, comprising:
receiving a set of position data;
determining a start data point and a stop data point of the set of position data;
testing the position data between the start data point and the stop data point via comparison with data representing predetermined gestures; and
locating a gesture within the set of position data based on the testing.

11. The method of claim 10, wherein the testing includes calculating a B-spline for the position data between the start data point and the stop data point.

12. The method of claim 11, further including determining an L2 norm based on a difference between the B-spline for the position data and a predetermined B-spline for a predetermined gesture.

13. The method of claim 12, further including determining a closest matching gesture determined from a set of the positional data between the start data point and the stop data point, wherein the set includes determined positional data having a sufficient number of data points to represent all allowable gestures.

14. A gesture recognition device, comprising:
a spline generating device to generate a spline based on a set of positional data;
a normalization device to normalize the spline; and
a goodness determination device to determine a goodness value based on how closely the spline correlates with a spline representing a gesture stored in a gesture vocabulary, and return the gesture if the goodness value exceeds a threshold value.

15. The gesture recognition device of claim 14, wherein the spline is a B-spline.

16. The gesture recognition device of claim 14, wherein the normalization device includes a convex hull determination and scale device.

17. The gesture recognition device of claim 14, wherein the normalization device includes a moment calculation device.

18. The gesture recognition device of claim 14, wherein the normalization device includes a translation device.

19. The gesture recognition device of claim 14, further including a gesture vocabulary device to store the gesture vocabulary.

20. A gesture recognition system, comprising:
a raw data acquisition device to acquire a set of positional data;
a spline generating device to generate a spline based on the set of positional data;
a normalization device to normalize the spline; and
a goodness determination device to determine a goodness value based on how closely the spline correlates with a spline representing a gesture stored in a gesture vocabulary, and return the gesture if the goodness value exceeds a threshold value.

21. The gesture recognition system of claim 20, wherein the spline is a B-spline.

22. The gesture recognition system of claim 20, wherein the normalization device includes a convex hull determination and scale device.

23. The gesture recognition system of claim 20, wherein the normalization device includes a moment calculation device.

24. The gesture recognition system of claim 20, wherein the normalization device includes a translation device.

25. The gesture recognition system of claim 20, further including a gesture vocabulary device to store the gesture vocabulary.

26. The gesture recognition system of claim 20, wherein the raw data acquisition device includes a mouse.

27. The gesture recognition system of claim 20, wherein the raw data acquisition device includes an I/O device.

28. The gesture recognition system of claim 20, wherein the raw data acquisition device includes a touchpad.

29. The gesture recognition system of claim 20, wherein the raw data acquisition device includes a videocamera.

30. An article comprising:
a storage medium having stored thereon first instructions that when executed by a machine result in the following:
receiving position data;
generating a detected spline based on the position data;
applying a normalization scheme to the detected spline to generate a normalized spline; and
determining a goodness value by comparing the normalized spline with gesture splines representing gestures stored in a gesture database.

31. The article according to claim 30, wherein the normalization scheme includes determining and scaling a convex hull of the detected spline.

32. The article according to claim 30, wherein the normalization process includes determining at least one moment of the detected spline.

33. The article according to claim 30, wherein the normalization process includes implementing a translation invariance scheme.

34. The article according to claim 30, wherein the normalized spline includes a normalized basis function and a predetermined number of normalized control points.

35. The article according to claim 30, wherein each of the gesture splines include a gesture basis function and gesture control points.

36. The article according to claim 30, wherein the goodness value is determined after calculating an L2 norm of the distances between respective normalized control points and gesture control points of the gesture splines.

37. The article according to claim 30, wherein a matching gesture is outputted if the goodness value is above a predetermined threshold.

38. An article comprising:
a storage medium having stored thereon first instructions that when executed by a machine result in the following:
receiving a set of position data;
determining a start data point and a stop data point of the set of position data;
testing the position data between the start data point and the stop data point via comparison with data representing predetermined gestures; and
locating a gesture within the set of position data based on the testing.

39. The article of claim 38, wherein the testing includes calculating a B-spline for the position data between the start data point and the stop data point.

40. The article of claim 38, further including determining an L2 norm based on a difference between the B-spline for the position data and a B-spline for a predetermined gesture.

41. The article of claim 38, further including determining a closest matching gesture determined from a set of the positional data between the start data point and the stop data point, wherein the set includes determined positional data having a sufficient number of data points to represent all allowable gestures.
